(19) United States
(12) Patent Application Publication
(10) Pub. No.: US 2024/0228289 A1
(43) Pub. Date: Jul. 11, 2024

(54) Apparatus and Method for Gaseous Hydrocarbon Self-Catalyzation, Reforming, and Solid Carbon Deposition

(71) Applicant: The Regents of the University of California, Oakland, CA (US)

(72) Inventors: Mostafa M. Abuseada, Culver City, CA (US); Timothy S. Fisher, Los Angeles, CA (US)

(73) Assignee: The Regents of the University of California, Oakland, CA (US)

(21) Appl. No.: 18/559,306

(22) PCT Filed: May 5, 2022
(86) PCT No.: PCT/US2022/072137

§ 371 Date: Nov. 6, 2023

Related U.S. Application Data
(60) Provisional application No. 63/185,144, filed on May 6, 2021.

(51) Int. Cl. C01B 32/05; C01B 3/26

(52) U.S. Cl. CPC C01B 32/05; C01B 3/26; C01P 2002/72; C01P 2002/82; C01P 2004/03

(57) ABSTRACT

This disclosure relates to an apparatus and method of transforming gaseous hydrocarbons such as methane into hydrogen and carbon. In some embodiments, the method includes flowing gaseous hydrocarbon onto a porous substrate in a reaction zone; and exposing the porous substrate to a concentrated solar irradiation in the reaction zone such that the porous substrate and gases surrounding the porous substrate absorb the concentrated solar irradiation producing heat, wherein the heat decomposes the gaseous hydrocarbon into hydrogen gas and carbon. The carbon may deposit onto the porous substrate as high quality graphitic carbon.

### CROSS-REFERENCE TO RELATED APPLICATIONS

This application claims the benefit of and priority under 35 U.S.C. § 119(e) to U.S. Provisional Patent Application Ser. No. 63/185,144 entitled “Gaseous Hydrocarbon Self-Catalyzing Solar Reforming and Solid Carbon Deposition”, filed May 6, 2021, which is incorporated herein by reference in its entirety for all purposes.

### FIELD OF THE DISCLOSURE

The present invention generally relates an apparatus and method for producing hydrogen and/or carbon. More specifically, the present invention relates to an apparatus and method for transforming a gaseous hydrocarbon such as methane into hydrogen and carbon.

### BACKGROUND

Dominant energy production processes worldwide continue to affect the environment adversely and lead to global warming, which may be primarily due to CO₂ emissions from nonrenewable energy sources such as fossil fuels. With the increasing global population and energy demand, the global gross electricity production is on the rise where the production had a yearly increase of 3.9% in 2018 and approximately 31.7% over the earlier decade. The main sources of electricity production consisted of 67% non-renewable and CO₂ emitting combustible fuels. The percentage of fossil fuels further increases when we consider the heating market separately. This circumstance creates a high interest in more sustainable energy sources, where hydrogen has been perceived as a desirable sustainable fuel.

Current industrial processes for power, fuel, and commodity production may be responsible for massive, ongoing CO₂ emissions that adversely affect the stability of the Earth's climate with potentially disastrous consequences. Increased use of hydrogen as a fuel and a chemical building block may reduce CO₂ emissions in critical sectors, but current hydrogen production technologies also involve high greenhouse gas emissions. Specifically, steam methane reforming (SMR) may rely on fossil-fuel combustion to derive heat and constitutes 95% of the current hydrogen production with substantial CO₂ emissions. The entirety of the combustion heating may be avoided by utilizing a portion of 75,000 TeraWatts of solar power reaching the Earth's surface to meet the growing demand for hydrogen (e.g. 10 MT/yr in the US and growing). Clean hydrogen production that avoids combustion derived heat may offset approximately 10 kg of CO₂ emissions per kg H₂.

SMR may be a cost-effective current hydrogen production process. Water electrolysis driven by solar energy is an emerging alternative, with potentially 30% solar-to-hydrogen efficiency but significantly higher production costs. Similar challenges exist for alternative solar-driven processes, such as CO₂/H₂O dissociation. Moreover, alternatives such as dry reforming of methane with CO₂ have attracted recent attention, but related emissions benefits are projected to be small.

Prior studies used solar heating for SMR involved the use of specialized catalysts to achieve fuel conversion. However, the resulting catalyst and support introduce additional costs, complexity, and durability limits related to sintering and catalyst deactivation from solid carbon deposition. SMR may offer an intrinsic advantage in producing one more mole of hydrogen per reactant mole of methane molecule than pyrolysis, but this benefit comes with the cost of higher heat input, ΔH_{SMR}*=206 kJ/mol. Using hydrogen's lower heat value of −242 kJ/mol, at least 54% of the additional hydrogen from SMR may be recycled for process reaction heat.

### SUMMARY OF THE DISCLOSURE

Various embodiments relate to a method of decomposing gaseous hydrocarbons such as methane gas, the method including: flowing gaseous hydrocarbon onto a porous substrate in a reaction zone; and exposing the porous substrate to a concentrated solar irradiation in the reaction zone such that the porous substrate and gases surrounding the porous substrate absorb the concentrated solar irradiation producing heat, where the heat decomposes the gaseous hydrocarbon into hydrogen gas and carbon.

Further, various embodiments also relate to a reactor for decomposing a gaseous hydrocarbon including: a concentrated solar source; a reaction chamber; a porous substrate positioned at the end of the reaction chamber; and a nozzle for flowing the gaseous hydrocarbon into the reaction chamber and onto the porous substrate, where the concentrated solar source emits a concentrated solar irradiation onto the porous substrate while the substrate is exposed to the gaseous hydrocarbon such that the porous substrate and surrounding gases absorb the concentrated solar irradiation producing heat, where the heat decomposes the gaseous hydrocarbon into hydrogen and carbon.

### BRIEF DESCRIPTION OF THE DRAWINGS

The description will be more fully understood with reference to the following figures and data graphs, which are presented as various embodiment of the disclosure and should not be construed as a complete recitation of the scope of the disclosure.

FIG. 1 illustrates a reaction chamber in accordance with an embodiment of the invention.

FIG. 2 is a view of an implementation of the reaction chamber of FIG. 1.

FIG. 3 schematically illustrates a reactor for performing the concentrated solar pyrolysis process in accordance with an embodiment of the invention.

FIG. 4A is a plot with heat flux distribution and cumulative power as functions of radius at the focal plane.

FIG. 4B is a temperature profile of the carbon felt's back surface during CH₄ decomposition obtained using an IR camera.

FIG. 4C is an image of the processed carbon felt with carbon deposition.

FIGS. 5A-5C illustrate various results from a methane decomposition process.

FIGS. 6A-6C are various scanning electron microscope (SEM) images of postprocessed carbon felt in accordance with an embodiment of the invention.

FIGS. 7A-7C are various plots of structural analysis on a carbon felt product in accordance with an embodiment of the invention.

FIG. 8A illustrates a carbon felt/cloth substrate before the methane solar decomposition.

FIG. 8B illustrates a corresponding Raman spectroscopy of the carbon substrate illustrated in FIG. 8A.

FIG. 9A illustrates a carbon substrate after a methane solar decomposition.

FIG. 9B illustrates a corresponding Raman spectroscopy of the carbon substrate after the methane solar decomposition illustrated in FIG. 9A.

FIG. 10A illustrates a frontside image of a carbon substrate after a methane solar decomposition.

FIG. 10B illustrates a corresponding Raman spectroscopy of the frontside of the carbon substrate after the methane solar decomposition illustrated in FIG. 10A.

FIG. 11A illustrates a backside image of the carbon substrate after the methane solar decomposition of FIGS. 10A and 10B.

FIG. 11B illustrates the corresponding Raman spectroscopy of the backside of the carbon substrate after methane solar decomposition illustrated in FIGS. 10A and 10B.

FIG. 12 schematically illustrates a reactor in accordance with an embodiment of the invention.

FIGS. 13A-13D illustrate various configuration of the sidewalls in the nozzle region of the reactor described in connection with FIG. 12.

FIG. 14 illustrates an SEM image of the carbon felt's central region after CH₄ decomposition and carbon deposition.

FIGS. 15A and 15B schematically illustrate various reactors in accordance with various embodiments of the invention.

### DETAILED DESCRIPTION

Contemporary carbon and hydrogen production processes may release significant CO₂ emissions with negative consequences for the Earth's climate. Disclosed herein is a process in which concentrated irradiation from a simulated solar source converts methane to high-value graphitic carbon and hydrogen gas. In some embodiments, methane flows within a photothermal reactor through pores of a thin substrate, with the process reaching steady-state conditions from room temperature within the first minute of irradiation by several thousand suns. Methane decomposes primarily into hydrogen while depositing highly graphitic carbon that grows conformally over ligaments in the thin substrate. The localized solar heating serves to capture solid carbon into a readily extractable form while maintaining active deposition site density with persistent catalytic activity until the ligaments eventually coalesce to block the flow. Even with a large flow area through regions of lower irradiation and temperature, methane conversions and hydrogen yields of approximately 70% may be achieved, and 58% of the inlet carbon may be fully captured in graphitic form.

Disclosed herein is a process for producing high-yield hydrogen and graphite from methane in a reaction driven by direct, concentrated solar-thermal energy. The process may exhibit a fast cold-startup time response of approximately 1 min to reach steady-state thermochemical conditions and produces a high-quality microporous graphitic product. The global market for graphite, primarily used in Li ion batteries and steel production, may be approximately 2 million metric tons (MMT). On the basis of the stoichiometric ratio of carbon to hydrogen in methane, these markets could potentially be served by the disclosed process while producing approximately 0.67 MMT of H₂ annually. For scale context, the annual production of natural gas in the US is 30 trillion ft³ or approximately 616 MMT. The elemental carbon content of this annual production is approximately 466 MMT, with a corresponding 150 MMT of hydrogen. Therefore, applying the solar process described here to only a minute fraction (<0.5%) of US-produced natural gas could satisfy today's entire global graphite market while also providing clean hydrogen fuel.

Moreover, challenges related to the intermittency of renewable energy sources are at least in part ameliorated by their intensive capture during peak insolation, e.g., via concentrating solar power systems, to create fuels that serve both as storage media and eventual power sources. The process disclosed herein may provide such systems at practical scales and efficiencies. For example, the input energy per unit mass of hydrogen produced is a common metric to compare different hydrogen production technologies, and minimizing this metric may allow the disclosed approach to scaling up. Other hydrogen production technologies such as alkaline electrolysis requires approximately 50 kWh of electricity per kg of hydrogen produced. If this electricity were derived from photovoltaic panels with 20% efficiency, then 250 kWh of direct solar energy would be required per kg of hydrogen. In the new laboratory-scale system reported here, the corresponding metric is about 1 order of magnitude larger, and substantial reductions are anticipated by scaling up to higher overall flow rates and introducing heat loss mitigations. Success in such an endeavor could ameliorate the climate challenge by adapting the approach to a range of uses, from partial conversion of natural gas for blended hydrogen transmission, to zero-carbon full conversion, or even to negative carbon with renewably sourced biogas feedstocks, all while coproducing high-value graphitic solids.

Various embodiments of the invention relate to solar methane dissociation. Solar methane dissociation may be a possible near-term alternative to SMR in starting with a carbon-containing fuel and ending with a carbon-free fuel as well as a potentially valuable carbon product, which may bring operational costs of producing high quality hydrogen gas to a competitive level. Thermal decomposition of CH₄, also known as methane cracking or pyrolysis, is an endothermic reaction that breaks down CH₄ into solid carbon and H₂ gas through the following global dissociation reaction:

$${CH}_{4} \to C + 2 {H}_{2} ( ΔH° = \frac{74.6 kJ}{mol} ) \qquad ( 1 )$$

This reaction may proceed at temperatures above 1000 K. This reaction may include many complex chemical kinetic pathway that include several light and stable hydrocarbons, mainly acetylene, ethylene, and ethane, as intermediaries, and minor products.

Solar-thermal pyrolysis of methane may produce hydrogen and an amorphous solid carbon black. Indirect solar heating may be performed in a tubular reactor with a 50 kW pilot scale, producing temperatures above 1600 K and hydrogen yields up to 88%, with lower yields of solid carbon black (e.g. less than 63%). High overall decomposition rates by using volumetric absorption in suspended particle flows and packed beds, including substrate temperatures in the range of 1300-1600 K may produce the highest hydrogen yields. However, these substrate temperatures produce carbon black and issues such as solid obstruction of flow and window deposition present practical challenges. Metal catalysts may decrease reaction temperatures to as low as 873 K and produce small quantities of partially graphitized carbon nanostructures. However, common issues with metal catalysis related to cost, sustained activity, and postprocess purification make such systems less amenable to methane decomposition at a large scale.

As discussed above, previous hydrocarbon dissociation processes mainly produce carbon black. Carbon black may include a high amount of amorphous carbon structures. Various embodiments of the invention relate to solar-thermal methane pyrolysis that uniquely produces high-value graphitic carbon with enhanced surface area. Graphitic carbon may include a high level of crystallinity which may increase the overall quality and utility of the carbon. Graphitic carbon may include a limited amount of amorphous carbon material. The method may involve a direct solar-thermal reactor with a locally heated region that mitigates the practical limitations of carbon deposition on the reactor walls and windows, avoids high overall reactor operating temperatures that increase heat losses, and allows photothermal catalytic effects that may not be possible in indirect solar reactors. The solar-driven coproduction of graphitic carbon with hydrogen may allow this process to meet clean hydrogen demand while also providing electrode materials for the rapidly growing Li-Ion battery market.

A promising and sustainable alternative to the current hydrogen production technologies that typically use non-renewable energy and lead to emission of COₓ product, such as steam methane reforming, is the direct solar-thermal decomposition of gaseous hydrocarbons such as methane using concentrated solar-thermal power. Several challenges that face this technique include carbon separation and clogging issues in addition to efficiency and economical limitations.

In this invention, a 10 KW high flux solar simulator (concentrated light source) may be used in the process of gaseous hydrocarbon solar decomposition. The gaseous hydrocarbon may be methane or a methane containing gas such as natural gas. A custom-designed and built solar simulator may produce controllable radiative heat flux up to 4500 suns, which may be sufficient to bring reactor operating temperatures above 1500° K. In an attempt to eliminate carbon deposition and clogging issues of solar reactors in addition to extract a high-value deposition product, the flow may be directed and decomposed (e.g. pyrolyzed) within a porous carbon substrate (e.g. a carbon cloth), producing an outflow of hydrogen gas in addition to other carbon containing species at a lower carbon concentration compared to the inflow gas. The use of the porous carbon substrate may also work to significantly enhance heat transfer to the flowing medium as a result of the increased surface area, which thus increases the methane decomposition/conversion efficiency.

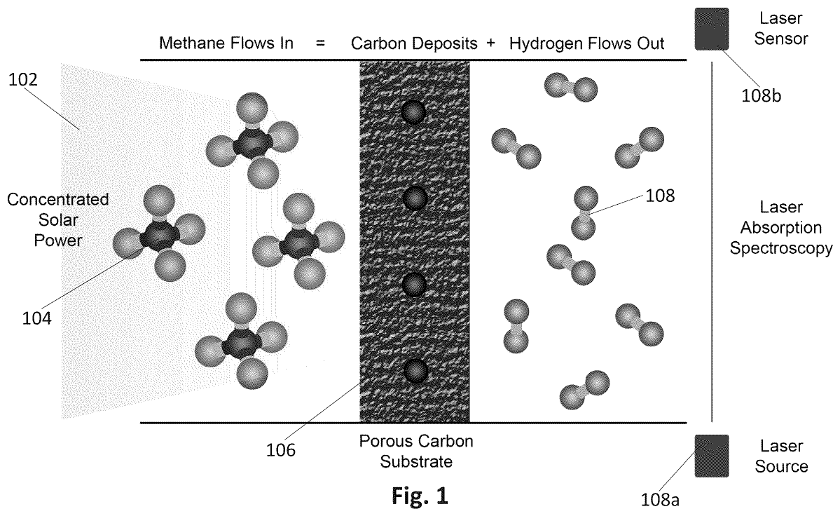

FIG. 1 schematically illustrates a reactor in accordance with an embodiment of the invention. A concentrated solar light 102 may be introduced to a gaseous hydrocarbon 104 which may disassociate the carbon and the hydrogen 108. The carbon may be trapped into a porous carbon substrate 106 while the hydrogen 108 is left to flow out as hydrogen gas. In some embodiments, the porous carbon substrate 106 may include carbon cloth or felt. In some embodiments, the porous carbon substrate 106 may be setup in a roll to roll process where fresh substrate may be continuously fed into the reaction chamber. The roll to roll process may be continuously operated.

In some embodiments, the concentrated solar light 102 may be light from the sun which may be concentrated through one or more concentrators (e.g. reflectors, refractors, mirrors). The concentrators may be variable concentrators (e.g. variable mirrors) which may vary the amount of light applied to the flow of methane gas. The disassociation of methane into carbon and hydrogen is an endothermic reaction. In some embodiments, the axis of the concentrated solar light 102 may be altered to alter the strength of the light depending on the optimal amount of light for a specific situation.

In some embodiments, the concentrated solar light 102 may be produced by a light source such as a xenon light source. In some embodiments, a combination of light from the sun and a light source may be used to perform the reaction. For example, the sun may produce the light during the day whereas at night, a light source may be used to perpetuate the reaction. Further, the reaction may strictly be performed using light from the light source. Light from the light source may approach the porous carbon substrate 106 from one direction whereas light from the sun may approach from another direction. The gaseous hydrocarbon 104 (e.g. methane) may be a transparent gas which may not absorb a significant amount of concentrated solar light. The porous substrate 106 may absorb the concentrated solar light 102 within its solid web producing local heating of the gaseous hydrocarbon as it flows through the porous web and photocatalysis that accelerates the decomposition. The porous substrate 106 and the gases surrounding the porous substrate 106 may absorb the concentrated solar light 102 to produce heat which may decompose the gaseous hydrocarbon 104 into hydrogen gas and carbon. The gaseous hydrocarbon 104 and/or the porous carbon substrate 106 may include no separate catalyst. The gaseous hydrocarbon 104 may also include a carrier gas such as hydrogen. It has been discovered that the carbon quality is enhanced with addition of a carrier gas such as hydrogen to the gaseous hydrocarbon 104.

To quantify the extent of gaseous hydrocarbon cracking (e.g. methane cracking) and the conversion efficiency under varied operating conditions and temperatures, optical emission spectroscopy (an IR camera) may be used for monitoring the carbon substrate. In some embodiments, the reactor may include a laser source 108a and a laser sensor 108b to perform laser absorption spectroscopy to identify the composition of the outflowing gas 108 stream in-situ.

While it has been demonstrated that the disclosed process yields high purity hydrogen gas 108 as the product, there may still be carbon from the gaseous hydrocarbon 104 in the outflowing hydrogen gas 108. In some embodiments, the outflowing gas 108 may be at least partially reflowed into the inflowing gaseous hydrocarbon 104 and thus reflowed onto the porous carbon substrate 106 in order to further extract carbon onto the porous carbon substrate 106.

While a porous carbon substrate 106 has been specifically illustrated, other types of porous substrates have also been demonstrated with a high degree of effectiveness. For example, the porous substrate 106 may be an inorganic felt (e.g. glass fiber), organic material (e.g. cotton and/or wool), carbon fiber felt, or polymer fibers. In some embodiments, carbon may be previously pyrolyzed onto the carbon fiber felt before use as the porous substrate 106. In some embodiments, carbon may be previously pyrolyzed onto the polymer fibers before use as the porous substrate 106. The pre-pyrolzyation step may be performed by the processes and reactor described throughout the present disclosure. In some embodiments, the porous substrate 106 may not include a previous pyrolyzation step. Results where the porous substrate 106 includes glass fibers have demonstrated highly graphitic carbon though the deposited carbon may not be as clean or smooth as using a porous substrate 106 including carbon felt.

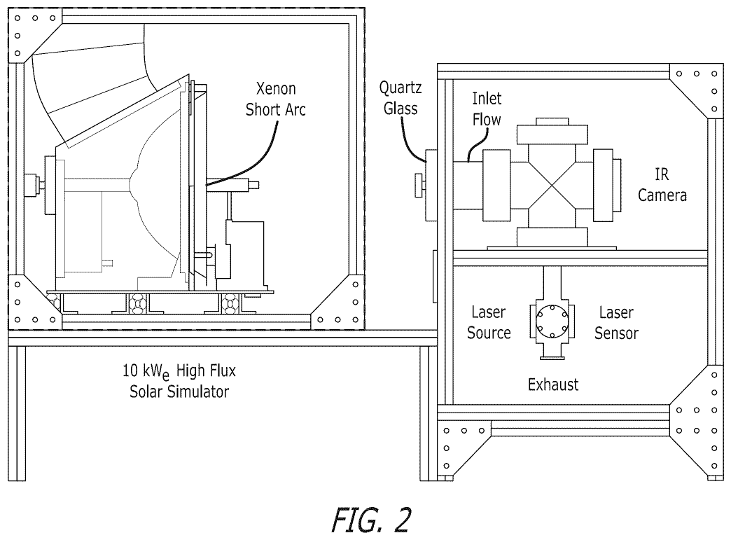

FIG. 2 schematically illustrates a reactor for hydrocarbon disassociation in accordance with an embodiment of the invention. Additionally, the quality of the produced carbon may be evaluated using scanning electron microscopy in order to optimize the quality of the carbon product by controlling a variety of variables such as the heat flux, the flow rate, the operating pressures, etc.

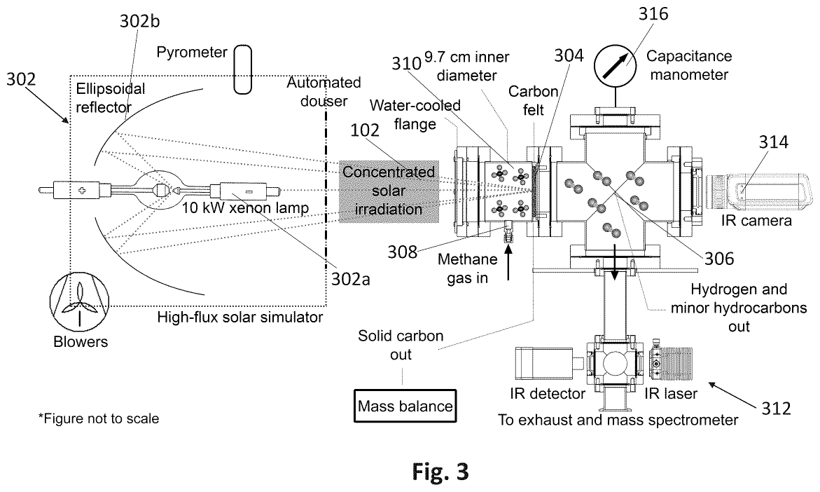

FIG. 3 schematically illustrates a reactor for performing the concentrated solar pyrolysis process in accordance with an embodiment of the invention. The concentrated solar pyrolysis process may be a solar methane decomposition process. The reactor may include a radiative solar source 302 which may simulate solar activities. The radiative solar source 302 may be a custom-built high-flux solar simulator that produces controllable intensities up to a peak of 4500 suns (e.g. 1 sun=1 kW/m²) with a Lorentzian distribution at the focal plane. The radiative solar source 302 may include a high intensity light source 302a which may be focused through a light concentrator 302b.

In some embodiments, the radiative solar source 302 may be a first concentrated solar source configure to expose the porous substrate 304 to the concentrated solar irradiation 102 from a first direction and a second concentrated solar source configured to expose the porous substrate 304 to the concentrated solar irradiation 102 from a second direction. In some embodiments, the first direction goes towards a front side of the porous substrate 304 and the second direction goes towards a back side of the porous substrate 304.

A thin porous substrate 304 may be placed at the reactor's focal plane with direct irradiation and methane flow, which provides a high active reaction site density. Methane gas may flow through an inlet 308 onto a chamber 310 including the thin porous substrate 304. The methane may be pyrolyzed to extract carbon onto the thin porous substrate 304 leaving hydrogen gas. The hydrogen gas may flow into an output chamber 306. To enable real-time analysis of fuel conversion and chemical kinetics, the output hydrogen gas stream may be monitored by an exhaust and a mass spectrometer 312. The exhaust and mass spectrometer 312 may include an IR detector and/or IR laser and may be downstream from the output chamber 306. Additionally, an infrared (IR) camera 314 may directly monitor the temperature of the reaction zone on the thin porous substrate 304 from behind the substrate 304.

In some embodiments, the reactor may include one or more controllers which are configured to control the flow of methane through the inlet 308. In some embodiments, the reactor may include one or more controllers which are configured to control the amount of light produced through the radiative solar source 302. For example, the light concentrator 302b may be a variable light source which may be controlled by the one or more controllers. Also, the light source 302a may be a variable light source which may be controlled by the one or more controllers. In some embodiments, one or more controllers may control the axis of the radiative solar source 302 which may control the intensity of light irradiating the thin porous substrate 304.

In some embodiments, the reactor may be a stainless steel reactor. The reactor may include a quartz window (e.g. 10 cm diameter) to transmit light from the radiative solar source 302. In some embodiments, the inlet 308 may provide for metered inlet gas flowing through the porous felt substrate 304 that is mounted at the radiative solar source 302 focal plane. The reactor may include an automated monitoring and control system. The automated monitoring and control system may include of various mass flow controllers. For example, the reactor may include a mass detector 312 including an infrared (IR) detector and/or IR laser. The reactor may also include an IR camera 312 for spatial temperature measurements. The reactor may also include a capacitance manometer 316 for pressure monitoring. The reactor may further one or more of include relays, valves, and/or a controller. The relays and/or valves may be controlled by the controller based on measurements from the mass flow controllers. For example, the above mentioned one or more controllers may use information from these sensor systems to control the radiative solar source 302 and/or the inlet 308. In some embodiments, the reactor may include a reflow system which takes the outflowing gas from the output chamber 306 and at least partially redirects it back into the inlet 308 for additional processing. While the outflowing gas may be substantially pure hydrogen gas, the outflowing gas may still include carbon which may be further processed through reflowing.

The radiative solar source 302 may include a light source 302a such as a 10 kW xenon short-arc lamp. The light source 302a may be focused by a concentrator 302b (e.g. an ellipsoidal reflector). The concentrator 302b may include an elliptical reflector, a parabolic reflector, a compound reflector, or an array of flat reflectors. The light source 302a may be powered through a variable DC power supply configured to supply current range of 100-200 A. The light source 302a may closely resemble the sun's light output and include controllable photonic output which may reproduce natural variations of insolation (e.g., sunrise/sunset and clouds) for testing real-world scenarios.

In some embodiments, the thin porous substrate 304 may be carbon felt. The carbon felt may include polyacrylonitrile (PAN) fibers. The PAN fibers may include 10 μm diameter, an overall felt diameter and thickness of 6.9 cm and 3.2 mm, a solid volume fraction of 0.048, and an average separation between fibers of 40 μm. In some embodiments, the thin porous substrate 304 may be an alumina/silica ceramic cloth. The alumina/silica ceramic cloth may include 46% alumina and 54% silica by weight, and may be of the same overall dimensions as the carbon felt. Prior to methane decomposition, the carbon felt may be pretreated under the same or similar thermal power and distribution from the high-flux solar simulator, and for a duration of approximately 20 min in a vacuum environment. The thermal pretreatment may purify the carbon felt from volatiles and trapped air to obtain more accurate weight measurements of the carbon felt before and after processing to determine the total mass of carbon produced and captured. Upon the thermal pretreatment, the carbon felt may lose approximately 3% of its original mass. This observation is consistent with the thermogravimetric analysis for temperatures up to 1300 K.

In some embodiments, two continuous-wave distributed feedback interband cascade lasers and a PV detector may be used to directly monitor the mole fractions of CH₄, C₂H₄, and C₂H₆ after absorption by the thin porous substrate 304. Laser absorption spectroscopy may allow for accurate monitoring of trace products (e.g. C₂H₄ and C₂H₆).

In some embodiments, a compact, high-resolution residual gas analyzer may be used as an in situ mass spectrometer and calibrated for monitoring H₂, CH₄, C₂H₂, C₂H₄, and C₂H₆. Representative laser absorption spectroscopy (LAS) uncertainties, including both the uncertainty associated with measurement noise and spectroscopic constants, are listed in Table 1 for measured CH₄, C₂H₄, and C₂H₆ mole fractions. Table 1:

TABLE 1

| | | line strength | overall |
|---|---|---|---|
| species | 1 − σ (%) | uncertainties (%) | uncertainties (%) |
| CH₄ | 2 | 5 | 5.4 |
| C₂H₄ | 12 | 10 | 15.6 |
| C₂H₆ | 3 | 4 | 5 |

The mass spectrometer system may be calibrated to provide relative quantitative results (e.g. mole fractions) for CH₄, H₂, C₂H₂, C₂H₄, and C₂H₆ using known or reference gas stream compositions. Upon calibration, differences between reference mole fractions and measured values result in the following uncertainty estimates for different species based on their relative residuals: H₂=±1.5%, CH₄=±2.7%, C₂H₂=±4.2%, C₂H₄=±28%, and C₂H₆=±35%. The relatively large uncertainty estimates in the latter two species may be due to their low concentrations (<0.5%) within the product stream and resulting low signal-to-noise ratios. As such, the two gas-phase measurement methods may be complementary, with the LAS method providing more reliable measurements of C₂H₄ and C₂H₆ and a higher maximum measurement rate of CH₄ but not detecting H₂ or C₂H₂, which are both attained in the mass spectroscopy system.

Raman spectra were obtained using a spectrometer including a 532 nm laser with a 40× achromat objective lens and a visible-light CCD detector in an imaging spectrometer. Scanning electron microscope (SEM) images were obtained using a SEM and its secondary electron (SE) detector. Elemental analysis was performed using the SEM's integrated energy-dispersive X-ray spectroscopy (EDS) unit). Surface area was measured using a high-performance adsorption surface characterization analyzer and N₂ absorption at 77 K, where the surface area was quantified per the Brunauer-Emmett-Teller (BET) method. X-ray diffraction measurements were obtained using an X-ray powder diffractometer equipped with a Cu Kα source. Thermogravimetric analysis was performed in an argon inert atmosphere for temperatures up to 1300 K.

The IR camera 312 may be calibrated to a maximum temperature of 2100° C. with an estimated uncertainty of +2%, or +25 K in the temperature range. The emissivity for measurements from the IR camera 312 may be 0.9, and the temperature uncertainty may be ±22 K at a maximum temperature of 1550 K. The maximum temperature rise from the back side (measured with the IR camera 312) to the front side (directly illuminated) of the thin porous substrate 304 may be less than 200 K.

Without limitation to any particular theory, with the product stream composition (e.g. mole fractions) may be fully quantified such that the process methane conversion (X_{CH4}), hydrogen yield (Y_{H2}), and carbon yield (Y_{C}) may be determined. The analysis may include only the five most prevalent species in the product stream (0.1% or higher), which are H₂, CH₄, C₂H₂, C₂H₄, and C₂H₆. Formulating a balance over the hydrogen atoms produces the following equation:

$$2 {\dot{n}}_{CH 4 , i n} = {\dot{n}}_{out} ( {x}_{H 2} + 2 {x}_{CH 4} + {x}_{C 2 H 2} + 2 {x}_{C 2 H 4} + 3 {x}_{C 2 H 6} \qquad ( 2 )$$

where \dot{n} is the molar flow rate and x; is the mole fraction of species i. Note that “out” has been omitted from the mole fractions of the product stream for brevity. In some examples, no mole fractions may be used for the single-species inlet stream. Rearranging Equation 2 yields an expression to quantify the total molar flow rate out as:

$${\dot{n}}_{out} = \frac{2 {\dot{n}}_{CH 4 , i n}}{{x}_{H 2} + 2 {x}_{CH 4} + {x}_{C 2 H 2} + 2 {x}_{C 2 H 4} + 3 {x}_{C 2 H 6}} \qquad ( 3 )$$

Upon obtaining the outlet molar flow rate, the methane conversion, defined as the relative difference between inlet and outlet methane flow rates, may be calculated as:

$${X}_{CH 4} = \frac{{\dot{n}}_{CH 4 , i n} - {\dot{n}}_{out} {x}_{CH 4}}{{\dot{n}}_{CH 4 , i n}} \qquad ( 4 )$$

Similarly, the overall hydrogen yield, defined as the fraction of all inlet hydrogen that emerges as hydrogen gas in the product stream, may be quantified as:

$${Y}_{H 2} = \frac{{\dot{n}}_{H 2 , out}}{2 {\dot{n}}_{CH 4 , i n}} = \frac{{\dot{n}}_{out} {x}_{H 2}}{2 {\dot{n}}_{CH 4 , i n}} \qquad ( 5 )$$

Then, by formulating a balance over the carbon atoms, the rate of carbon mass deposition may be quantified as:

$${\dot{m}}_{C} = [ {\dot{n}}_{CH 4 , i n} - {\dot{n}}_{out} ( {x}_{CH 4} + 2 {x}_{C 2 H 2} + 2 {x}_{C 2 H 4} + 2 {x}_{C 2 H 6} ) ] {M}_{C} \qquad ( 6 )$$

where M_{C} is the molar mass of carbon. In a similar manner to the total hydrogen yield, the total carbon yield is obtained from

$${Y}_{C} = \frac{{\dot{m}}_{C}}{{M}_{C} {\dot{n}}_{C H 4 , i n}} \qquad ( 7 )$$

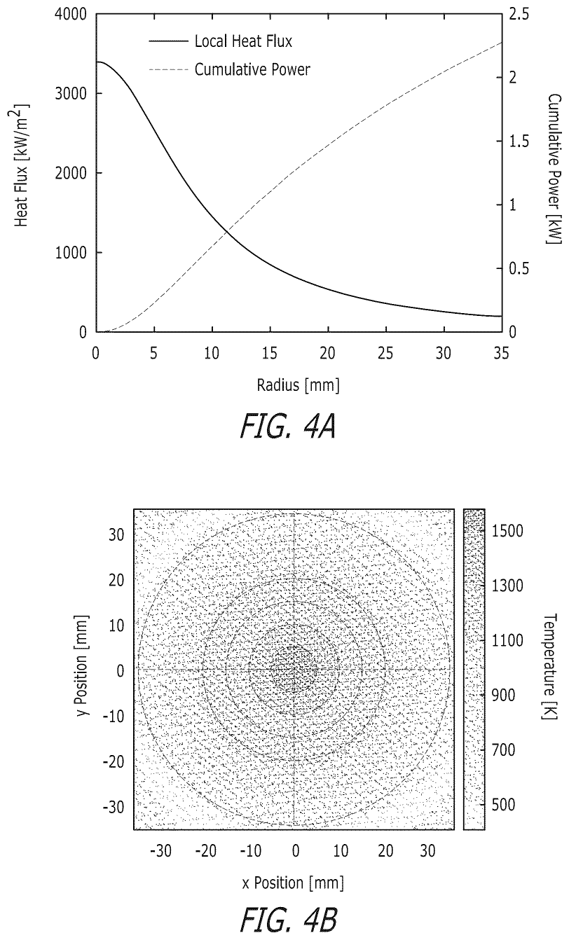

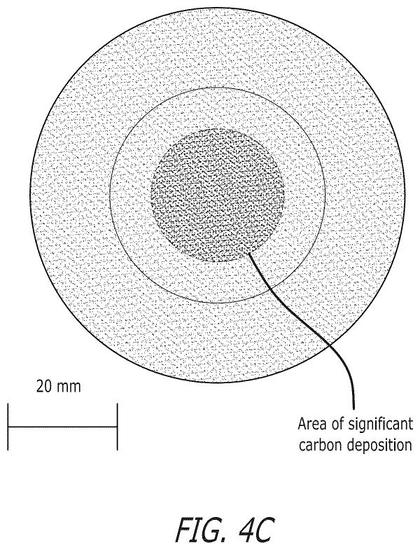

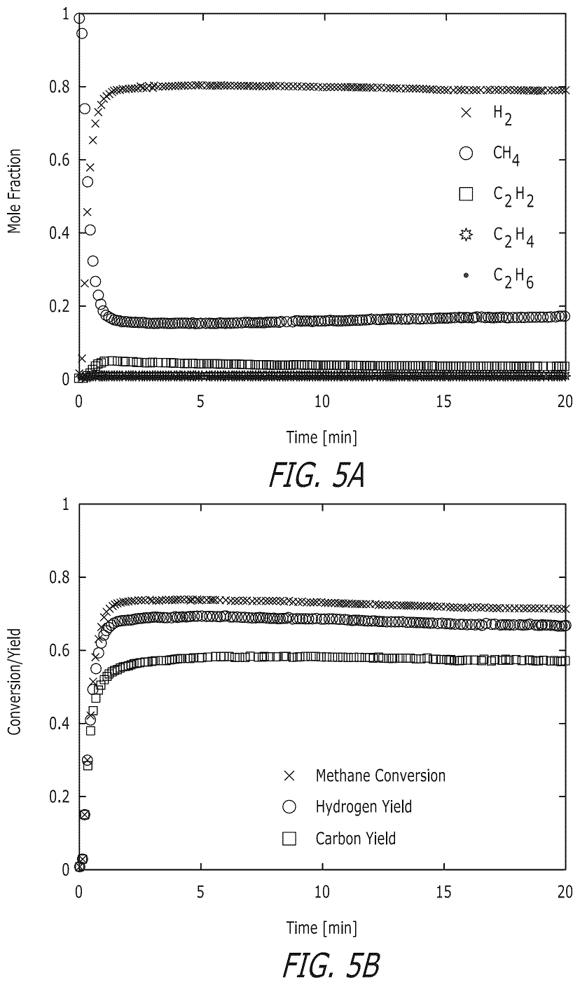

In some embodiments, methane decomposition through the carbon felt may be performed under a maximum central irradiance of 3400 suns (e.g. 2.24 KW gross radiant power), with 99.999% pure methane inlet flowing at 100 sccm under an operating pressure of 25 Torr (3.33 kPa) for a test duration of 20 min. FIGS. 4A-4C illustrate various results from a methane decomposition process with conditions including a 100 sccm flow rate of methane, 25 Torr of pressure, 2.24 KW of gross radiant power, and 20 min reaction period. FIG. 4A is a plot with Heat flux distribution and cumulative power as functions of radius at the focal plane. FIG. 4B is a temperature profile of the carbon felt's back surface during CH₄ decomposition obtained using an IR camera. The centered black rings are at r=5, 10, 15, and 20 mm and illustrate the distribution and angular uniformity. FIG. 4C is an image of the processed carbon felt with carbon deposition. As illustrated in FIG. 4A, when the solar irradiance instantaneously focuses on the thin porous substrate 304 initially at room temperature, the carbon felt reaches steady-state temperatures within the first minute of insolation. FIG. 4B illustrates the temperature profile at steady-state temperatures. As a result, methane decomposition may rapidly decrease the methane concentration in the product stream to yield primarily hydrogen and solid carbon deposition. Upon methane decomposition for 20 min, the weight of the thin porous substrate 304 may be increased by 0.62 g. This increased weight may represent a 58% of the carbon mass in the inlet methane. The processed felt shown in FIG. 4C includes an indication of significant central carbon deposition.

As illustrated in FIG. 4B, IR temperature mapping may reveal a large temperature gradient in the substrate that is a consequence of the Lorentzian light source distribution. The central circular region (e.g. at 25 mm diameter) of thin porous substrate 304 are illustrated to include temperatures well above 1000 K, beyond which the substrate temperatures decrease markedly. The local heat flux at the edge of this central region (e.g. r=12.5 mm) may be the equivalent of about 1100 suns, and the area-weighted average from the center to r=12.5 mm may be the equivalent of about 1800 suns. In some embodiments, the system may include a more optimized temperature gradient which includes a more uniform temperature across the thin porous substrate 304. For example, the entire substrate may be illuminated with an area-weighted average power of the equivalent of about 1800 suns.

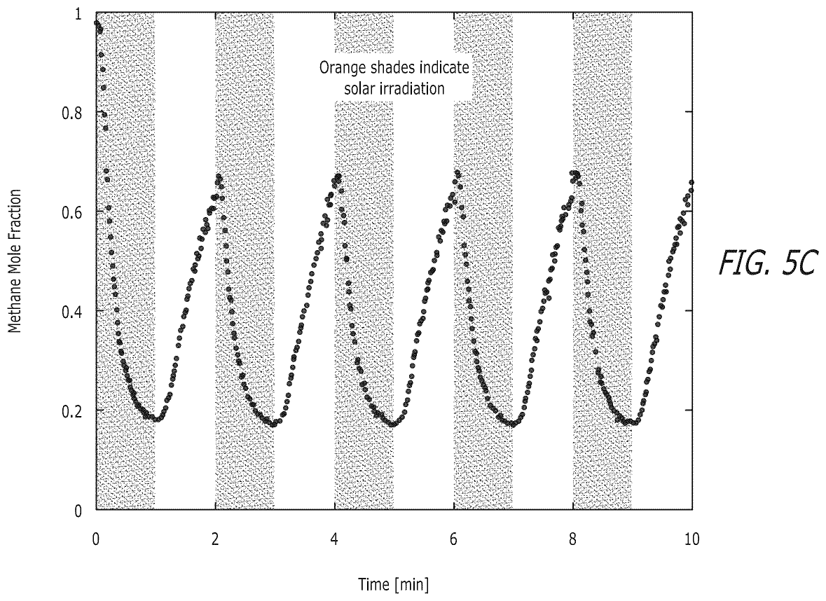

FIGS. 5A-5C illustrate various results from a methane decomposition process. The method decomposition process may be performed at a 100 sccm flow rate of methane, 25 Torr of pressure, 2.24 KW of gross radiant power, and 20 min reaction period. Real-time monitoring results may be obtained from a calibrated mass spectrometer. FIG. 5A illustrates mole fractions in the product stream. FIG. 5B illustrate example methane conversion and product yields. FIG. 5C illustrates example methane mole fraction in the product stream under periodic irradiation as obtained by laser absorption spectroscopy. The hydrogen molar flow rate in the yield expression (e.g. Equation 5) may be determined from monitoring of the product stream which may be seen in FIG. 5A. With the vast majority of the hydrocarbon product flow as CH₄ (e.g. mole fraction=0.16), the overall hydrogen yield for the conditions discussed in connection with FIGS. 4A-4C may be 69% which may be seen in FIG. 5B. Because the reaction pathways may also yield minor hydrocarbon byproducts (C₂H₂, C₂H₄, and C₂H₆), a methane conversion percentage may be 73%. From a mass balance analysis with the foregoing yields, the expected carbon weight and yield are 0.627 g and 58.3% as compared to the 58% measured capture, indicating that virtually all carbon deposition occurs on the thin porous substrate 304. The difference between the methane conversion and the solid carbon yield may be a consequence of minor hydrocarbon products (e.g. mainly C₂H₂).

A significant challenge with many thermal energy systems, including solar-thermal fuels and electric power production, may be their slow startup time response of 1 hour or more. In contrast, the disclosed reactor may include a much faster time response of approximately 1 min to reach steady-state thermochemical conditions from room temperature. The fast response may be primarily attributed to the low thermal mass of the thin porous substrate 304, which serves as both an efficient light absorber and deposition substrate. This feature enables the possibility of high levels of process control under realistic field insolation conditions. In some embodiments, the light source may be cycled in an on/off manner with a period of 2 minutes under constant methane flow. The product stream monitoring results from laser absorption spectroscopy in FIG. 5C demonstrate the repeatability of both the fast response and the return to high methane conversion levels.

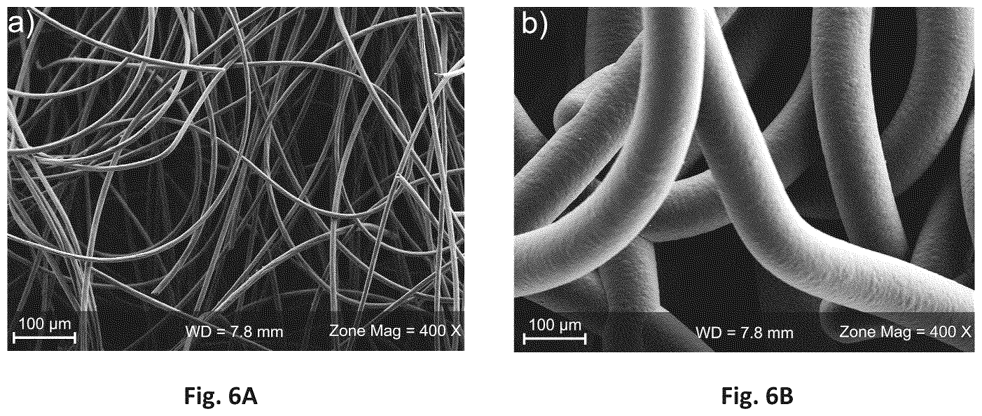

As illustrated in FIG. 5B, methane conversion may remain stable for 20 minutes during significant accumulation of solid carbon on the thin porous substrate 304. FIGS. 6A-6C are various scanning electron microscope (SEM) images of postprocessed carbon felt in accordance with an embodiment of the invention. These images are a morphology analysis on carbon felt product for methane decomposition at 100 sccm flow rate, 25 Torr of pressure, 2.24 KW of gross radiant power, and 20 min reaction period. FIG. 6A shows the original carbon felt. FIG. 6B shows the center of the postprocessed carbon felt. FIG. 6C is a cross-section at the central carbon felt region demonstrating the nature and amount of carbon deposition. Comparing the original fibers to the processed fibers (e.g. FIGS. 6A and 6B), the carbon fiber thickness at the center of the reaction zone increases significantly from 10 μm to 90 μm in the region with a maximum temperature in the reaction zone of approximately 1500K. FIG. 6C shows the original core of the fiber and the deposited carbon layers, where the image illustrates a less dense and microporous structure which is correlated through the N₂ adsorption and BET analysis discussed below. The deposited carbon layers may be layered flake graphite which may be higher quality than other graphite products.

In some embodiments, the deposited carbon may include graphene, graphite, carbon nanotubes, or carbon black which is deposited conformally onto the surfaces of the porous substrate. The conformal carbon coating from adjacent elements or ligaments of the porous substrate may coalesce to form a continuous structure.

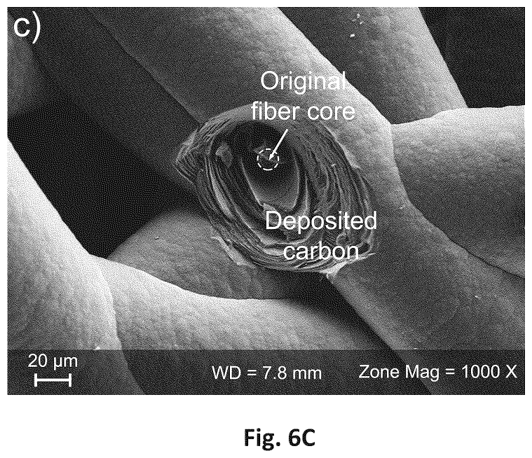

FIGS. 7A-7C are various plots of structural analysis on a carbon felt product in accordance with an embodiment of the invention. The carbon felt product for methane decomposition may be performed at 100 sccm flow rate, 25 Torr of pressure, 2.24 KW of gross radiant power, and 20 min reaction period. FIG. 7A illustrates fiber diameter as a function of radial distance from the center as compared to the original carbon felt diameter. FIG. 7B illustrates raman spectra of the carbon product at the center and 5 mm radial distance as compared to the original carbon felt. FIG. 7C illustrates an X-ray diffraction (XRD) spectra of the carbon product at the central region as compared to the original carbon felt. As illustrated in FIG. 7A, the thickness of the conformal graphitic deposition depends strongly on the radial position with the majority of deposition in the hot central region (e.g. r≤10 mm). FIG. 7B illustrates the raman spectra of the carbon felt before and after deposition. The presence of a distinct 2D peak and low D/G peak ratio in the deposited carbon clearly indicates the formation of a high-quality graphitic carbon at the center of the substrate as well as at radius, r=5 mm. Conversely, for comparison, the original carbon felt's Raman spectrum lacks these features. The formation of a layered graphitic structure is also apparent in the SEM image of FIG. 6C, which shows a fractured cross section with deposited ringlike layers surrounding the original microfiber core. Fog 8C illustrates an XRD scan which shows the crystalline structure of the carbon within the central region compared to the original carbon felt. The average interplanar distances determined from the (002) reflection position and Bragg's law are 3.56 and 3.42 Å for the original carbon felt and carbon product, respectively. The latter spacing is consistent with turbostratic graphite and clearly indicates high graphitization.

Table 2 is a summarization of Brunauer-Emmett-Teller (BET) surface characterization results for the original carbon felt and processed carbon product in two central regions: r=0-5 mm and r=5-10 mm. The sample mass after outgassing is indicated in Table 2, and the BET range used for surface area quantification corresponds to relative pressures (P/P°) of 0.1-0.3. In some embodiments, CH₄ decomposition occurs at 100 sccm flow rate, 25 torr pressure, 2.24 KW gross radiant power, and 20 min reaction period.

TABLE 2

| radius | sample mass | BET surface area | |
|---|---|---|---|
| (mm) | (mg) | (m²/g) | BET constant |
| 0-5 | 102 | 7.58 ± 0.09 | 2.07 |
| 5-10 | 137 | 3.03 ± 0.09 | 2.23 |
| original | 85 | 1.54 ± 0.04 | 3.49 |

From SEM images illustrated in FIG. 7A, the fiber diameters may be 97 μm, 69 μm, and 20 μm at radius 0 mm, 5 mm, and 10 mm from the center of the carbon felt product, compared to an initial fiber diameter of 10 μm in the carbon felt. Without considering microporosity, the specific surface area may scale as 1/Dₜ, where Dₜ is the fiber diameter. Using the maximum and minimum diameters within each range (0 mm-5 mm and 5 mm-10 mm), the specific surface area may be expected to decrease by approximately 7-10 times for the 0 mm-5 mm region and 2-7 times for the 5 mm-10 mm region. However, the specific surface areas instead increase by 5- and 2-fold. This indicates that the deposited carbon product possesses significant microporosity, which may be expected to be useful in electrochemical energy storage applications.

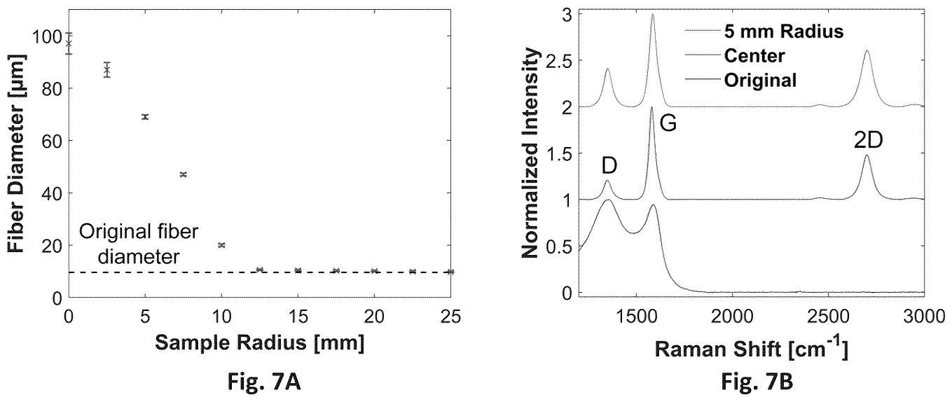

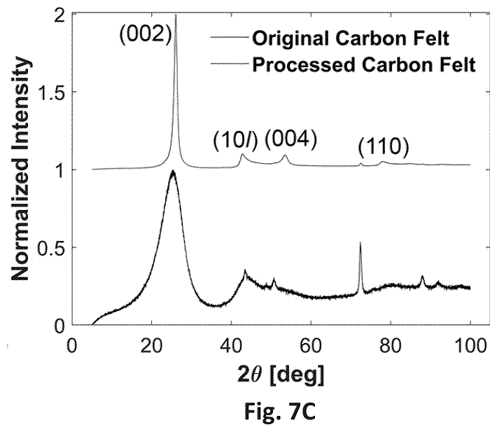

FIG. 8A illustrates a carbon felt/cloth substrate before the methane solar decomposition. FIG. 8B illustrates a corresponding raman spectroscopy of the carbon substrate illustrated in FIG. 8A. In FIG. 3, the first two peaks may correspond to the D peak 802 and G peak 804 of a graphitic sample, while the third peak may correspond to the nitrogen peak (and hence may be ignored here). As illustrated, the D/G peaks ratio is relatively high initially, which indicates that the carbon felt/cloth substrate may include graphitic carbon of high disorder. Additionally, the overall intensities are low, indicating a relatively weak signal from the original carbon felt substrate. Further, a graphene 2D peak is not present in the carbon felt/cloth substrate.

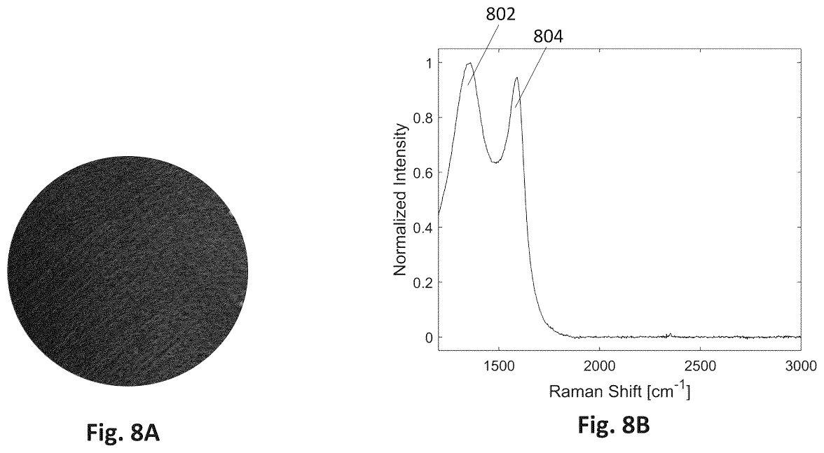

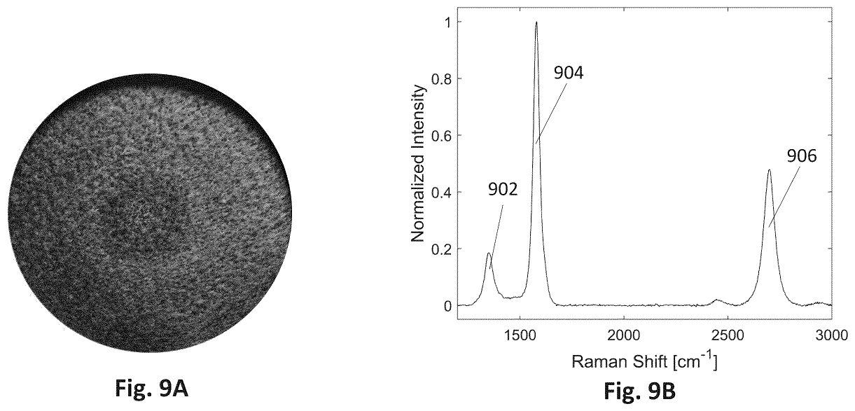

FIG. 9A illustrates a carbon substrate after a methane solar decomposition. FIG. 9B illustrates a corresponding raman spectroscopy of the carbon substrate after the methane solar decomposition illustrated in FIG. 9A. The methane solar decomposition had operating conditions of 25 torr and 100 A (concentrated light source current supply), with an inlet flow of methane (CH4) of 100 SCCM. The methane solar decomposition was conducted for 20 minutes. The carbon felt substrate was weighted before the methane solar decomposition (the carbon cloth/felt substrate illustrated in FIG. 8A) and after the methane solar decomposition (the carbon cloth/felt substrate illustrated in FIG. 9A). The substrate's weight after the methane solar decomposition (the carbon cloth/felt substrate illustrated in FIG. 9A) was 2.276 g, while it was 2.225 g prior to the methane solar decomposition (the carbon cloth/felt substrate illustrated in FIG. 8A). This change of mass may include losses in the substrate's weight due to volatiles in addition to loss of loose substrate fragments. Therefore, the determined conversion/capture efficiency of the methane (CH₄) to carbon (C) may be a minimum efficiency value (the true value may be greater than or equal to this value). From the aforementioned measurements, the carbon weight gain is 0.051 g which yields a conversion/capture efficiency of equal to or greater than approximately 5%.

An example calculation for calculating amount of carbon captured by the carbon cloth/felt substrate shown below:
Flow rate: 100 SCCM (cm³/min)
Density of methane at standard conditions (0° C. and 1 atm): 0.71746 kg/m³ (from NIST database)
Conversion ratio: 100% (maximum conversion possible)
Rate of flow of methane:

$$100 \frac{{cm}^{3}}{min} \times \frac{1}{{100}^{3}} \frac{{m}^{3}}{{cm}^{3}} \times 0.71746 \frac{kg}{{m}^{3}} \times 1000 \frac{g}{kg} = 0.071746 \frac{g}{min} of {CH}_{4}$$

Rate of deposition of carbon:

$$0.071746 \frac{g}{min} \times 1 \times \frac{12}{16} = 0.05381 \frac{g}{min} of C$$

Duration of experiment: 20 min
Amount of carbon flow in:

$$20 min \times 0.05381 \frac{g}{min} = 1.07619 g of C$$

In FIG. 9B, as in FIG. 8B, the first two peaks may correspond to the D peak 902 and G peak 904 of a graphitic sample. As compared to FIG. 8B, the D/G peaks ratio has reduced, indicating that the graphitic carbon product is less disordered. Further, the overall peak intensities are relatively higher, indicating a stronger signal from the processed carbon felt substrate. Unlike FIG. 8B, in FIG. 9B the 2D peak 906 is present.

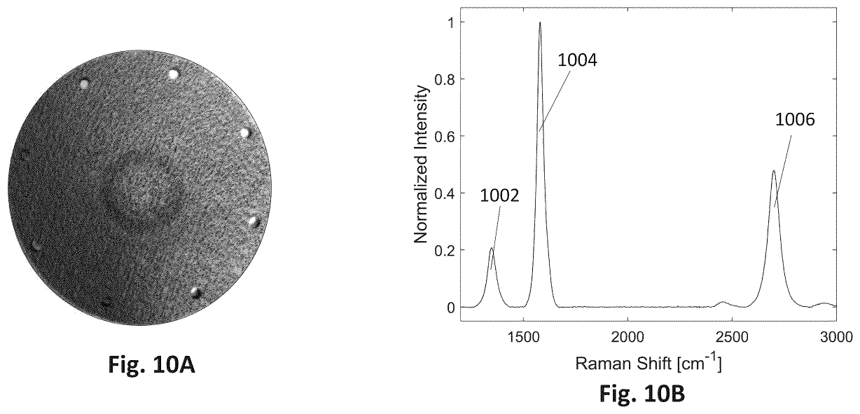

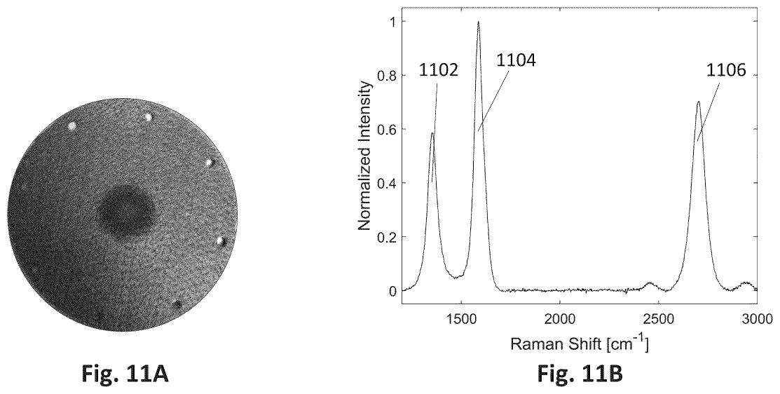

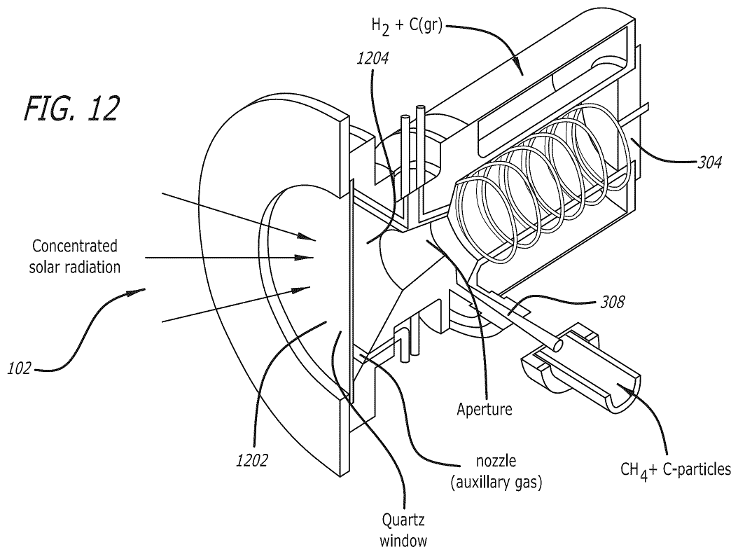

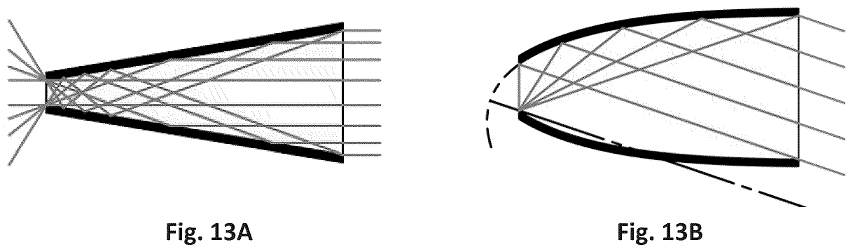

FIG. 10A illustrates a frontside image of a carbon substrate after a methane solar decomposition. FIG. 10B illustrates a corresponding raman spectroscopy of the frontside of the carbon substrate after the methane solar decomposition illustrated in FIG. 10A. FIG. 11A illustrates a backside image of the carbon substrate after the methane solar decomposition of FIGS. 10A and 10B. FIG. 10B illustrates the corresponding raman spectroscopy of the backside of the carbon substrate after methane solar decomposition illustrated in FIG. 10A. The methane solar decomposition had operating conditions of 25 torr and 160 A (concentrated light source current supply), with an inlet flow of methane (CH₄) of 100 SCCM for 20 minutes. The carbon felt substrate was weighted before the methane solar decomposition (illustrated in FIG. 8A) and after the methane solar decomposition (illustrated in FIG. 10A). The substrate's weight after the methane solar decomposition was 2.568 g, while it was 2.121 g before the methane solar decomposition. Therefore, the carbon weight gain was 0.447 g and conversion/capture efficiency was greater than or equal to approximately 42%.

In FIGS. 10B and 11B, as in FIGS. 8B and 9B, the first two peaks may correspond to the D peak 1002, 1102 and G peak 1004, 1104 of a graphitic sample. Unlike FIG. 8B, in FIGS. 10B and 11B the 2D peak 1006, 1106 is present. As compared to the original substrate (FIG. 8B) and that after the previous methane solar decomposition (FIG. 9B), the D/G peaks ratio has significantly reduced on the front surface (FIG. 10B; facing the concentrated light source), indicating that the graphitic carbon product may be much less disordered. The overall peak intensities are relatively higher than in FIG. 9B (especially for the front surface; FIG. 10B), indicating a stronger signal from the processed carbon felt substrate in FIGS. 10B and 11B. The graphene 2D peak is now present and is relatively high, indicating a good quality graphitic carbon product. The graphitic carbon product has been demonstrated as a highly pure carbon product with more than 99.8% purity. The carbon product includes limited residual nitrogen.

Results of the substrate back surface from the methane solar decomposition of FIG. 9B did not shown any change from that of the original. However, the results of the back surface illustrated in FIG. 11B indicate a slight change in the Raman spectroscopy results, where the 2D peak is present, but at a low relative intensity.

With the invention presented here, the aforementioned challenges can be alleviated and the growing market needs can be met. The high-quality carbon co-product obtained through the solar-thermal decomposition of methane may be a key to making such a process more economical and industrially feasible.

In various embodiments of the invention, the growth rate of conformal graphitic films on the fiber substrate may be exceptionally high. For comparison, graphite-like films grown by chemical vapor deposition (CVD) on nickel indicated an effective growth rate of 1 μm/h with a maximum thickness of 500 nm. An earlier report of hot-wall thermal CVD by methane pyrolysis at temperatures, pressures, and flow rates similar to those in in the disclosed embodiments reported a maximum graphitic mass deposition rate of 20 mg/h on a graphite rod substrate, which corresponds to a film growth rate of approximately 5.7 μm/h. In contrast, various embodiments include mass deposition rates of approximately 1850 mg/h, which may be 93 times higher than the maximum reported for a CVD process. In some embodiments, the system may have a much larger reaction zone than the CVD process. In terms of film growth rates, various embodiments include a radial fiber growth rate of 135 μm/h in the center of the felt substrate. Prior work on solar methane pyrolysis with carbon black under a maximum irradiance of 3000 suns reported a carbon deposition rate on a catalyst mass basis of 2.83 mg/g_{cat} per minute. The graphitic deposition rate may be 28.2 mg/g_{cat} per minute which may be 10 times higher based on the total starting carbon felt mass of 1.10 g_{cat}. In some embodiments, the centrally heated portion of the circular felt substrate may only be approximately 10% of the felt's total area. In some embodiments, the carbon deposition and hydrogen production rates may be increased. For example, expanding the area of high heat flux via optics and/or decreasing the size of the flow area to minimize methane bypass through the lower-temperature annulus.

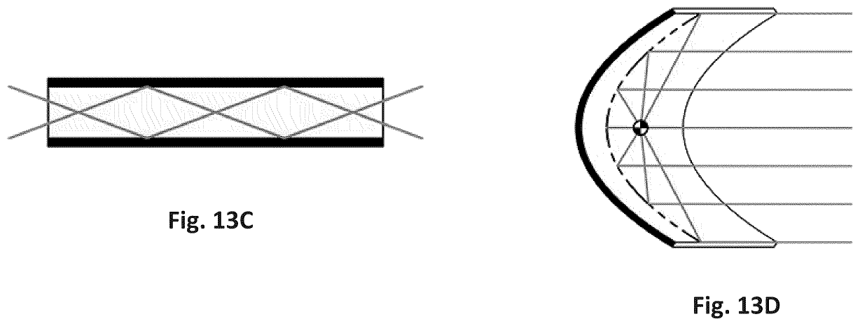

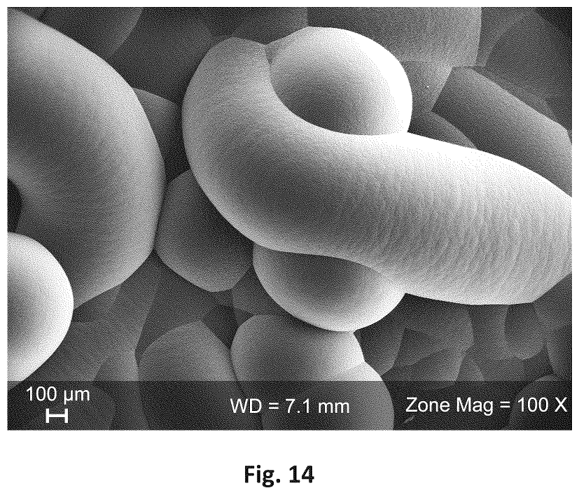

FIG. 12 schematically illustrates a reactor in accordance with an embodiment of the invention. The reactor shares identically numbered components to the reactor discussed in connection with FIG. 3. Discussion of these components will not be repeated in detail. The reactor includes a quartz window 1202 configured to be optically transparent to the concentrated solar radiation 102. The sidewalls 1204 of the reactor may have a certain optical shape designed to focus or defocus the concentrated solar radiation 102 in a certain fashion. The sidewalls 1204 in the nozzle region may be reflective to produce a secondary reflector to produce an optical effect to the incoming concentrated solar radiation 102. In some embodiments, it may be advantageous to diffuse the incoming concentrated solar radiation 102 into a certain pattern incident on the porous substrate 304. In some embodiments, the sidewalls 1204 in the nozzle region may be reflective and conical shaped. In some embodiments, the shape of the sidewalls 1204 may include a condenser, a concentrator (e.g. a compound parabolic concentrator), a light tube, or a trough. FIGS. 13A-13D illustrate various configuration of the sidewalls 1204 in the nozzle region of the reactor described in connection with FIG. 12. FIG. 13A illustrates an example sidewall configuration including a condenser in accordance with an embodiment of the invention. FIG. 13B illustrates an example sidewall configuration including a compound parabolic concentrator in accordance with an embodiment of the invention. FIG. 13C illustrates an example sidewall configuration including a light tube in accordance with an embodiment of the invention. FIG. 13D illustrates an example sidewall configuration including a trough in accordance with an embodiment of the invention.

Some embodiments may include a short residence time of gases in the reaction zone that nevertheless allows high graphitic growth rates and hydrogen gas yields. In some embodiments, the reaction residence time may be 0.054 sec. In comparison prior thermal CVD results may include a reaction residence time of 3 sec to 26 sec. In some embodiments, despite the graphitic carbon growth focused at the center of the substrate, there may be relatively high hydrogen yields from the bulk flow, much of which passes through substrate regions where little carbon is captured. Without limitation to any particular theory, the pyrolysis may be a kinetically limited process where the stepwise reduction in H:C ratio via hydrogen abstraction may not reach equilibrium or solid carbon formation within the residence time. This explanation is consistent with a relatively lower carbon yield compared to hydrogen yield.

The totality of the foregoing distinctions related to deposition rate, yield, and residence time may include a strong photothermal catalytic effect from the concentrated light source that enhances chemical kinetic rates. While thermal reaction pathways of methane pyrolysis to the gas-phase precursors of solid carbon (e.g., polycyclic aromatic hydrocarbons (PAHs)) are generally well-understood, it may be advantageous to further explain the latter transition steps from PAHs to solid carbon and its various forms. Prior work on strictly thermal methane decomposition has concluded that graphitic deposition impedes the reaction on a variety of carbon catalyst types, and that 40-50 graphene layers on iron particles are implicated in the deactivation of the catalyst. Conversely, a clear autocatalytic behavior has been demonstrated, with continued high activity with many orders of magnitude more graphene layers (˜105 layers, corresponding to >30 μm thickness). Recent insights into hot-carrier plasmonic photocatalytic decomposition of ammonia may apply to the disclosed methane decomposition process, where the intermediate presence of graphene-like domains could serve as plasmonic centers.

In some embodiments, the methane decomposition process may be examined through a long-duration lasting for 120 min under a flow rate of 100 sccm, pressure of 25 Torr, and gross radiant power of 2.24 KW. The net carbon product collected on the original felt was measured to be 2.26 g, which is more than twice the starting mass of the original carbon felt (2.05 g/g_{cat}). If only the area with active carbon deposition is considered (25 mm diameter, see FIG. 7A), the net carbon product collected increases to 15.5 g/g_{cat}. These results compare well to a net carbon production value of 0.34 g/g_{cat} in an earlier study with the same test duration of 120 min.

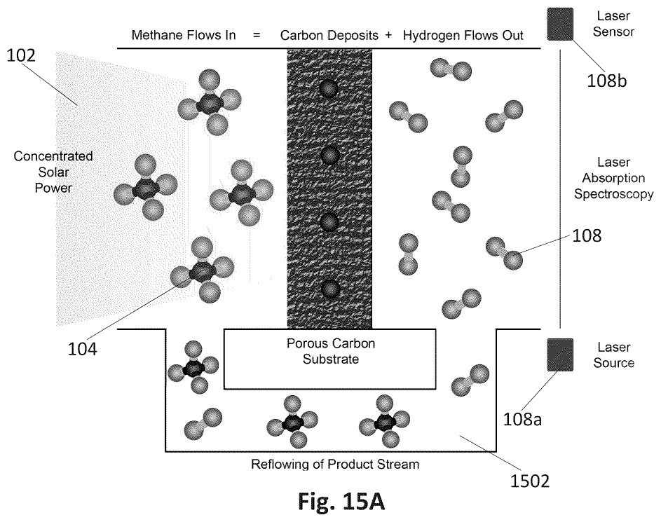

Methane conversion and total hydrogen yield may decrease steadily beyond the initial 20 min to values of 41% and 36% after 120 min. This may be attributed to the long-term degradation in process efficiency to increased flow resistance in the central region due to the decreasing porosity caused by highly enlarged and coalesced microfibers that increase flow bypass through annular regions. FIG. 14 illustrates an SEM image of the carbon felt's central region after CH₄ decomposition and carbon deposition. The decomposition may include a 120 min reaction time at 100 sccm flow rate, 25 Torr of pressure, and 2.24 kW of gross radiant power. To assess the influence of the starting substrate, a methane decomposition test may also be performed using an alumina/silica ceramic cloth under the same previous experimental conditions for 20 min. The results are nearly identical to those with the carbon felt in terms of methane conversion (75%) and hydrogen yield (71%) Thus, the disclosed methane decomposition process can be expanded to other porous starting substrates to yield a similar performance. As described above, the porous substrate may be an inorganic felt (e.g. glass fiber), organic material (e.g. cotton and/or wool), carbon fiber felt, or polymer fibers. In some embodiments, carbon may be previously pyrolyzed onto the carbon fiber felt before use as the porous substrate. In some embodiments, carbon may be previously pyrolyzed onto the polymer fibers before use as the porous substrate. In some embodiments, the porous substrate may not include a previous pyrolyzation step. Results where the porous substrate includes glass fibers have demonstrated highly graphitic carbon though the deposited carbon may not be as clean or smooth as using a porous substrate including carbon felt.

In some embodiments, the issue of increased flow resistance may be alleviated by a continuous roll-to-roll process that exploits the carbon fiber substrate's mechanical flexibility. As a result of the localized heated reaction region on the carbon felt, no noticeable carbon deposition occurred on the quartz window and/or on the reactor walls over the duration of reaction. Previous solar decomposition processes have presented issues with carbon deposition on the quartz window and/or on the reactor walls. In some embodiments, the solid carbon deposition from mass conservation using MS measurements over the 120 min period was 2.32±0.07 g, which compares with the actual mass measured (2.26±0.005 g) and further confirms that nearly all solid carbon is captured within the felt.

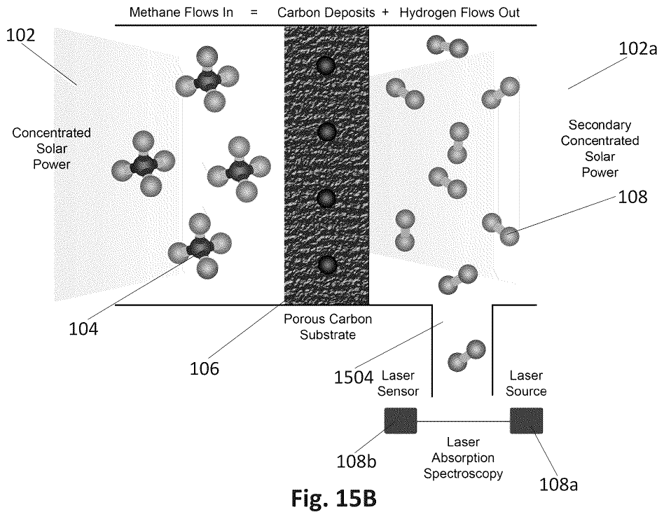

As discussed above, the outflow gas 108 may be at least partially reflowed into the inflowing gaseous hydrocarbon 104 and thus reflowed onto the porous carbon substrate 106 in order to further extract carbon onto the porous carbon substrate. FIG. 15A schematically illustrates a reactor in accordance with an embodiment of the invention. The reactor of FIG. 15A shares many identically labeled components with the reactor described in connection with FIG. 1. The description of these components is applicable to the reactor of FIG. 15A and these descriptions will not be repeated in details. The reactor may further include reflow piping 1502 configured to reflow the outflow gas 108 into the inflowing gaseous hydrocarbon 104 for further processing. The outflow gas 108 may include remaining carbon. By reflowing the outflow gas 108 onto the porous carbon substrate 106, the remaining carbon may be further extracted from the outflow gas 108. In some embodiments, the reflow piping 1502 may include a valve which may control the reflow of the outflow gas 108. In some embodiments, the valve may be controlled based on the measurements from the laser source 108a and the laser sensor 108b. Also, as discussed above, it has been discovered that the carbon quality is enhanced with addition of a carrier gas such as hydrogen to the inflowing gaseous hydrocarbon 104. In some cases, the outflow gas 108 may be approximately pure hydrogen and thus the outflow gas 108 may be used to improve the quality of the carbon product.

Further, as discussed above, the reactor may also include a secondary concentrated solar source which may approach the porous carbon substrate 106 from a different direction than the primary solar source. FIG. 15B schematically illustrates a reactor in accordance with an embodiment of the invention. The reactor of FIG. 15B shares many identically labeled components with the reactor described in connection with FIG. 1. The description of these components is applicable to the reactor of FIG. 15B and these descriptions will not be repeated in details. The reactor may further include a secondary concentrated solar power 102a which may approach the porous carbon substrate from a different direction than the primary solar source 102. In some embodiments, the secondary concentrated solar source 102a may approach the back side of the porous carbon substrate 106 and the primary concentrated solar source 102b may approach the front side of the porous carbon substrate 106. The reactor may include outflow piping 1504 which may be positioned to not obstruct the secondary concentrated solar power 102a. The laser source 108a and the laser sensor 108b may be positioned corresponding to the outflow piping 1504.

### Example Embodiments

Although many embodiments of the invention have been described in detail, it should be appreciated that the invention may be implemented in many other forms without departing from the spirit or scope of the invention. For example, embodiments such as enumerated below are contemplated:

Item 1: A method of decomposing gaseous hydrocarbon, the method comprising:
flowing gaseous hydrocarbon onto a porous substrate in a reaction zone; and
exposing the porous substrate to a concentrated solar irradiation in the reaction zone such that the porous substrate and gases surrounding the porous substrate absorb the concentrated solar irradiation producing heat,
wherein the heat decomposes the gaseous hydrocarbon into hydrogen gas and carbon.

Item 2: The method of Item 1, wherein the concentrated solar irradiation causes photocatalysis which accelerates the decomposition of the gaseous hydrocarbon into hydrogen gas and carbon.

Item 3: The method of Item 1, wherein the concentrated solar irradiation has a concentration factor of 100 or greater.

Item 4: The method of Item 1, wherein the gaseous hydrocarbon is high purity methane gas.

Item 5: The method of Item 1, wherein the gaseous hydrocarbon comprises a carrier gas mixed with methane.

Item 6: The method of Item 5, wherein the carrier gas is hydrogen gas.

Item 7: The method of Item 1, wherein the carbon comprises graphene, graphite, carbon nanotubes, or carbon black which is deposited conformally onto the surfaces of the porous substrate.

Item 8: The method of Item 7, wherein the conformal carbon coating from adjacent elements or ligaments of the porous substrate coalesce to form a continuous structure.

Item 9: The method of Item 7, wherein, after the carbon is deposited onto the porous substrate, the porous substrate is used to manufacture electrochemical energy storage devices.

Item 10: The method of Item 1, wherein the concentrated solar irradiation comprises solar light from the sun.

Item 11: The method of Item 1, wherein the concentrated solar irradiation comprises solar light from the sun augmented with an artificial light source.

Item 12: The method of Item 11, further comprising optimizing the amount of augmented artificial light from the artificial light source to keep a constant amount of irradiation.

Item 13: The method of Item 11, wherein the artificial light source comprises a plasma arc lamp, a halogen bulb, an LED, or a fluorescent bulb.

Item 14: The method of Item 11, wherein the artificial light source comprises a xenon arc lamp.

Item 15: The method of Item 11, wherein the concentrated solar irradiation comprises the solar light from the sun during a time when the sun is irradiating light into concentrators that concentrate the sun light into the reaction zone and the concentrated solar irradiation comprises artificial light when the sun is not irradiating light into the concentrators.

Item 16: The method of Item 1, wherein the concentrated solar irradiation comprises light from an artificial light source.

Item 17: The method of Item 1, wherein the porous substrate comprises a roll to roll substrate.

Item 18: The method of Item 17, further comprising operating the roll to roll substrate to continually maintain fresh porous substrate.

Item 19: The method of Item 1, wherein the porous substrate comprises carbon cloth or felt, metal mesh, or thin porous ceramics.

Item 20: The method of Item 1, further comprising concentrating a solar light source using a reflector.

Item 21: The method of Item 20, wherein the reflector comprises an elliptical reflector, a parabolic reflector, a compound reflector, or an array of flat reflectors.

Item 22: The method of Item 20, wherein the reflector comprises a variable reflector which adjusts the amount of concentrated solar irradiation in the reaction zone.

Item 23: The method of Item 1, wherein the reaction zone is housed within a reaction chamber.

Item 24: The method of Item 1, wherein the exposing the gaseous hydrocarbon to the concentrated solar irradiation occurs in multiple directions.

Item 25: The method of Item 1, wherein the gaseous hydrocarbon comprises natural gas.

Item 26: The method of Item 1, further comprising:
reflowing an output gas onto the porous substrate in the reaction zone; and
exposing the porous substrate to a concentrated solar irradiation in the reaction zone such that the reflowed gas further decomposes into hydrogen gas and carbon.

Item 27: A reactor for decomposing a gaseous hydrocarbon comprising:
a concentrated solar source;
a reaction chamber;
a porous substrate positioned at the end of the reaction chamber; and
a nozzle for flowing the gaseous hydrocarbon into the reaction chamber and onto the porous substrate,
wherein the concentrated solar source emits a concentrated solar irradiation onto the porous substrate while the substrate is exposed to the gaseous hydrocarbon such that the porous substrate absorbs the concentrated solar irradiation producing heat, and wherein the heat decomposes the gaseous hydrocarbon into hydrogen and carbon.

Item 28: The reactor of Item 27, wherein the concentrated solar irradiation causes photocatalysis which accelerates the decomposition of the gaseous hydrocarbon into hydrogen gas and carbon.

Item 29: The reactor of Item 27, wherein the concentrated solar irradiation has a concentration factor of 100 or greater.

Item 30: The reactor of Item 27, wherein the gaseous hydrocarbon is high purity methane gas.

Item 31: The reactor of Item 27, wherein the gaseous hydrocarbon comprises a carrier gas mixed with methane.

Item 32: The reactor of Item 31, wherein the carrier gas is hydrogen gas.

Item 33: The reactor of Item 27, wherein the carbon comprises graphene, graphite, carbon nanotubes, or carbon black which is deposited conformally onto the surfaces of the porous substrate.

Item 34: The reactor of Item 33, wherein the conformal carbon coating from adjacent elements or ligaments of the porous substrate coalesce to form a continuous structure.

Item 35: The reactor of Item 33, wherein, after the carbon is deposited onto the porous substrate, the porous substrate is capable of being integrated into electrochemical energy storage devices.

Item 36: The reactor of Item 27, wherein the concentrated solar irradiation comprises solar light from the sun.

Item 37: The reactor of Item 27, wherein the concentrated solar irradiation comprises solar light from the sun augmented with an artificial light source.

Item 38: The reactor of Item 37, wherein the amount of augmented artificial light from the artificial light source is optimized to keep a constant amount of irradiation.

Item 39: The reactor of Item 37, wherein the artificial light source comprises a plasma arc lamp, a halogen bulb, an LED, or a fluorescent bulb.

Item 40: The reactor of Item 37, wherein the artificial light source comprises a xenon arc lamp.

Item 41: The reactor of Item 37, wherein the concentrated solar irradiation comprises the solar light from the sun during a time when the sun is irradiating light into concentrators that concentrate the sun light into the reaction zone and the concentrated solar irradiation comprises artificial light when the sun is not irradiating light into the concentrators.

Item 42: The reactor of Item 27, wherein the concentrated solar irradiation comprises light from an artificial light source.

Item 43: The reactor of Item 27, wherein the porous substrate comprises a roll to roll substrate.

Item 44: The reactor of Item 43, wherein the roll to roll substrate is configured to continually maintain fresh porous substrate.

Item 45: The reactor of Item 27, wherein the porous substrate comprises carbon cloth or felt, metal mesh, or thin porous ceramics.

Item 46: The reactor of Item 27, wherein the concentrated solar source comprises a solar light source and a concentrator configured to concentrate light from the solar light source.

Item 47: The reactor of Item 46, wherein the concentrator comprises a reflector.

Item 48: The reactor of Item 47, wherein the reflector comprises an elliptical reflector, a parabolic reflector, a compound reflector, or an array of flat reflectors.

Item 49: The reactor of Item 47, wherein the reflector comprises a variable reflector which adjusts the amount of concentrated solar irradiation in the reaction zone.

Item 50: The reactor of Item 27, wherein the concentrated solar source comprises a first concentrated solar source configured to expose the porous substrate to the concentrated solar irradiation from a first direction and a second concentrated solar source configured to expose the porous substrate to the concentrated solar irradiation from a second direction.

Item 51: The reactor of Item 50, wherein the first direction goes towards a front side of the porous substrate and the second direction goes towards a back side of the porous substrate.

Item 52: The reactor of Item 27, wherein the gaseous hydrocarbon comprises natural gas.

Item 53: The reactor of Item 27, wherein a portion of the reaction chamber near the nozzle comprises reflective sidewalls with an optical shape to focus or defocus the concentrated solar irradiation.

Item 54: The reactor of Item 27, further comprising a controller configured to control the flow of the gaseous hydrocarbon through the nozzle and/or the amount of concentrated solar irradiation from the concentrated solar source.

Item 55: The reactor of Item 54, further comprising piping configured to reflow at least a portion of an output gas onto the porous substrate in the reaction zone,
wherein the controller is further configured to control a reflow nozzle to control the amount of output gas onto the porous substrate.

Item 56: The reactor of Item 54, further comprising a capacitance manometer for monitoring the pressure on the porous substrate.

Item 57: The reactor of Item 54, further comprising an infrared camera for monitoring the temperature of the porous substrate.

Item 58: The reactor of Item 54, further comprising a mass spectrometer of an output gas from the porous substrate.

Item 59: The reactor of Item 58, wherein the controller utilizes data from the mass spectrometer to alter the flow of the gaseous hydrocarbon and/or the amount of concentrated solar irradiation on the porous substrate.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. A method of decomposing gaseous hydrocarbon, the method comprising:
flowing gaseous hydrocarbon onto a porous substrate in a reaction zone; and
exposing the porous substrate to a concentrated solar irradiation in the reaction zone such that the porous substrate and gases surrounding the porous substrate absorb the concentrated solar irradiation producing heat,
wherein the heat decomposes the gaseous hydrocarbon into hydrogen gas and carbon.

2. The method of claim 1, wherein the concentrated solar irradiation causes photocatalysis which accelerates the decomposition of the gaseous hydrocarbon into hydrogen gas and carbon.

3. (canceled)

4. The method of claim 1, wherein the gaseous hydrocarbon is high purity methane gas.

5. The method of claim 1, wherein the gaseous hydrocarbon comprises a carrier gas mixed with methane.

6. The method of claim 5, wherein the carrier gas is hydrogen gas.

7. The method of claim 1, wherein the carbon comprises graphene, graphite, carbon nanotubes, or carbon black which is deposited conformally onto the surfaces of the porous substrate.

8. The method of claim 7, wherein the conformal carbon coating from adjacent elements or ligaments of the porous substrate coalesce to form a continuous structure.

9. The method of claim 7, wherein, after the carbon is deposited onto the porous substrate, the porous substrate is used to manufacture electrochemical energy storage devices.

10. The method of claim 1, wherein the concentrated solar irradiation comprises solar light from the sun.

11. The method of claim 1, wherein the concentrated solar irradiation comprises solar light from the sun augmented with an artificial light source.

12. The method of claim 11, further comprising optimizing the amount of augmented artificial light from the artificial light source to keep a constant amount of irradiation.

13. (canceled)

14. (canceled)

15. (canceled)

16. (canceled)

17. The method of claim 1, wherein the porous substrate comprises a roll to roll substrate.

18. The method of claim 17, further comprising operating the roll to roll substrate to continually maintain fresh porous substrate.

19. The method of claim 1, wherein the porous substrate comprises carbon cloth or felt, metal mesh, or thin porous ceramics.

20. The method of claim 1, further comprising concentrating a solar light source using a reflector.

21. The method of claim 20, wherein the reflector comprises an elliptical reflector, a parabolic reflector, a compound reflector, or an array of flat reflectors.

22. The method of claim 20, wherein the reflector comprises a variable reflector which adjusts the amount of concentrated solar irradiation in the reaction zone.

23. (canceled)

24. The method of claim 1, wherein the exposing the gaseous hydrocarbon to the concentrated solar irradiation occurs in multiple directions.

25. The method of claim 1, wherein the gaseous hydrocarbon comprises natural gas.

26. The method of claim 1, further comprising:
reflowing an output gas onto the porous substrate in the reaction zone; and
exposing the porous substrate to a concentrated solar irradiation in the reaction zone such that the reflowed gas further decomposes into hydrogen gas and carbon.
